(19) United States
(12) Patent Application Publication
(10) Pub. No.: US 2021/0241930 A1
(43) Pub. Date: Aug. 5, 2021

(54) CORROSION RESISTANT MATERIAL FOR HEAT EXCHANGERS

(71) Applicants: Richard A. Stoltz, Rowlett, TX (US); Jeff Bullington, Orlando, FL (US)

(72) Inventors: Richard A. Stoltz, Rowlett, TX (US); Jeff Bullington, Orlando, FL (US)

(21) Appl. No.: 17/155,351

(22) Filed: Jan. 22, 2021

Related U.S. Application Data
(60) Provisional application No. 62/964,901, filed on Jan. 23, 2020.

(51) Int. Cl. G21C 15/16; G21C 3/54

(52) U.S. Cl. CPC G21C 15/16; G21C 3/54

(57) ABSTRACT

A heat exchanger comprises a vessel, and a ceramic-nitride material disposed within the vessel and configured to separate a first fluid and a second fluid and/or gaseous fluid, and transfer a heat from the first fluid to the second fluid and/or gaseous fluid. The ceramic-nitride material also reduces corrosion.

### CROSS-REFERENCE TO RELATED APPLICATIONS

This application claims priority to U.S. Provisional Application Ser. No. 62/964,901, filed Jan. 23, 2020, the entire contents of which are incorporated herein by reference.

### STATEMENT OF FEDERALLY FUNDED RESEARCH

Not applicable.

### TECHNICAL FIELD OF THE INVENTION

The present invention relates in general to the field of heat exchangers. In particular, the present invention relates to a corrosion resistant material for heat exchangers used in molten salt reactors.

### BACKGROUND OF THE INVENTION

Without limiting the scope of the invention, its background is described in connection with molten salt reactors.

Oak Ridge National Laboratory Molten demonstrated the use of molten salt reactors in the 1960's. They built reactors that used thorium and/or uranium as fuel in molten salt. In addition, they used one type of reactor to propel an airplane. They operated the reactors for about four years.

The heat from the reactors can be used to generate steam that drives turbine-generators to produce electricity. In addition, the molten salt reactors can turn radioactive waste into waste that is not radioactive. The molten salt can contain thorium and/or uranium as fuel and can be operated for a long time without refueling (e.g., 80 years or more). Unlike conventional nuclear power plants, the molten salt reactors are inherently stable. Moreover, when the molten salt gets too hot it melts a drain plug and shuts down the reaction.

Hastelloy® alloys, which are nickel-molybdenum-based alloys, have been used in the molten salt reactors and/or heat exchangers. But, the Hastelloy® alloys have always shown some corrosion in a much shorter time than the life of the reactor.

Some examples of newer molten salt reactors are described in U.S. Pat. No. 10,056,160 and U.S. Published Patent Application No. 2005/0228363, both of which are hereby incorporated by reference in their entirety.

It is, therefore, desirable, to use a material that is more corrosive resistant in molten salt reactors and heat exchangers.

### SUMMARY OF THE INVENTION

In one embodiment, a method of reducing corrosion in a heat exchanger comprises: providing the heat exchanger having a ceramic-nitride material separating a first fluid and a second fluid and/or gaseous fluid; and transferring a heat from the first fluid to the second fluid and/or gaseous fluid via the ceramic-nitride material, wherein the ceramic-nitride material is corrosion resistant.

In one aspect, the ceramic-nitride material comprises a silicon-nitride material, an aluminum-nitride material, a boron-nitride material, or a combination thereof. In another aspect, the first fluid comprises molten salt; and the second fluid and/or gaseous fluid comprise steam, helium or carbon dioxide. In another aspect, the molten salt contains thorium fluoride. In another aspect, the heat exchanger is coupled to a molten salt reactor. In another aspect, the molten salt reactor is used to turn radioactive waste into waste that is not radioactive. In another aspect, the heat exchanger is coupled to a turbine-generator that produces electricity.

In another embodiment, a heat exchanger comprises: a vessel; and a ceramic-nitride material disposed within the vessel and configured to separate a first fluid and a second fluid and/or gaseous fluid, and transfer a heat from the first fluid to the second fluid and/or gaseous fluid.

In one aspect, the ceramic-nitride material comprises a silicon-nitride material, an aluminum-nitride material, a boron-nitride material, or a combination thereof. In another aspect, the ceramic-nitride material is corrosion resistant. In another aspect, the first fluid comprises molten salt; and the second fluid and/or gaseous fluid comprise steam, helium or carbon dioxide. In another aspect, the molten salt contains thorium fluoride. In another aspect, the heat exchanger is coupled to a molten salt reactor. In another aspect, the molten salt reactor is used to turn radioactive waste into waste that is not radioactive. In another aspect, the heat exchanger is coupled to a turbine-generator that produces electricity.

In another embodiment, a method of transferring heat comprises: providing a heat exchanger; passing a first fluid and a second fluid and/or gaseous fluid through the heat exchanger, wherein the first fluid is separated from the second fluid and/or gaseous fluid by a ceramic-nitride material; and transferring the heat from the first fluid to the second fluid and/or gaseous fluid using the ceramic-nitride material.

In one aspect, the ceramic-nitride material comprises a silicon-nitride material, an aluminum-nitride material, a boron-nitride material, or a combination thereof. In another aspect, the ceramic-nitride material is corrosion resistant. In another aspect, the first fluid comprises molten salt; and the second fluid and/or gaseous fluid comprise steam, helium or carbon dioxide. In another aspect, the molten salt contains thorium fluoride. In another aspect, the heat exchanger is coupled to a molten salt reactor. In another aspect, the molten salt reactor is used to turn radioactive waste into waste that is not radioactive. In another aspect, the heat exchanger is coupled to a turbine-generator that produces electricity.

The foregoing is a summary and thus contains, by necessity, simplifications, generalizations, and omissions of detail. Consequently, those skilled in the art will appreciate that this summary is illustrative only and is not intended to be in any way limiting. There aspects, features, and advantages of the devices, processes, and other subject matter described herein will be become apparent in the teachings set forth herein.

### BRIEF DESCRIPTION OF THE DRAWINGS

None.

### DETAILED DESCRIPTION OF THE INVENTION

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

Various embodiments of the present invention use nitride-ceramic materials, such as silicon-nitride (Si₃N₄) and/or aluminum-nitride (Al₃N₄) and/or boron-nitride (BN) ceramic materials, to greatly reduce or substantially eliminate corrosion of output pipe material, which are typically made of Hastelloy® alloys, in molten salt reactor systems. The ceramic-nitrides can be used individually or mixed with other materials to provide a ceramic material that will not corrode, is highly thermally conductive, and is thermally stable. They can also mixed to match the thermal expansion of Hastelloy® alloys. The nitride-ceramic materials can be used to replace Hastelloy® alloy as the one or more hottest, last heating stage in a molten salt reactor system heat-exchanger to avoid corrosion. These nitride-ceramics can also be used in other parts of a molten salt reactor system, such as piping, to avoid corrosion.

In one embodiment, a method of reducing corrosion in a heat exchanger comprises: providing the heat exchanger having a ceramic-nitride material separating a first fluid and a second fluid and/or gaseous fluid; and transferring a heat from the first fluid to the second fluid and/or gaseous fluid via the ceramic-nitride material, wherein the ceramic-nitride material is corrosion resistant.

In one aspect, the ceramic-nitride material comprises a silicon-nitride material, an aluminum-nitride material, a boron-nitride material, or a combination thereof. In another aspect, the first fluid comprises molten salt; and the second fluid and/or gaseous fluid comprise steam, helium or carbon dioxide. In another aspect, the molten salt contains thorium fluoride. In another aspect, the heat exchanger is coupled to a molten salt reactor. In another aspect, the molten salt reactor is used to turn radioactive waste into waste that is not radioactive. In another aspect, the heat exchanger is coupled to a turbine-generator that produces electricity.

In another embodiment, a heat exchanger comprises: a vessel; and a ceramic-nitride material disposed within the vessel and configured to separate a first fluid and a second fluid and/or gaseous fluid, and transfer a heat from the first fluid to the second fluid and/or gaseous fluid.

In one aspect, the ceramic-nitride material comprises a silicon-nitride material, an aluminum-nitride material, a boron-nitride material, or a combination thereof. In another aspect, the ceramic-nitride material is corrosion resistant. In another aspect, the first fluid comprises molten salt; and the second fluid and/or gaseous fluid comprise steam, helium or carbon dioxide. In another aspect, the molten salt contains thorium fluoride. In another aspect, the heat exchanger is coupled to a molten salt reactor. In another aspect, the molten salt reactor is used to turn radioactive waste into waste that is not radioactive. In another aspect, the heat exchanger is coupled to a turbine-generator that produces electricity.

In another embodiment, a method of transferring heat comprises: providing a heat exchanger; passing a first fluid and a second fluid and/or gaseous fluid through the heat exchanger, wherein the first fluid is separated from the second fluid and/or gaseous fluid by a ceramic-nitride material; and transferring the heat from the first fluid to the second fluid and/or gaseous fluid using the ceramic-nitride material.

In one aspect, the ceramic-nitride material comprises a silicon-nitride material, an aluminum-nitride material, a boron-nitride material, or a combination thereof. In another aspect, the ceramic-nitride material is corrosion resistant. In another aspect, the first fluid comprises molten salt; and the second fluid and/or gaseous fluid comprise steam, helium or carbon dioxide. In another aspect, the molten salt contains thorium fluoride. In another aspect, the heat exchanger is coupled to a molten salt reactor. In another aspect, the molten salt reactor is used to turn radioactive waste into waste that is not radioactive. In another aspect, the heat exchanger is coupled to a turbine-generator that produces electricity.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of.” As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step, or a limitation) or group of integers (e.g., feature(s), element(s), characteristic(s), property(ies), method/process(s) steps, or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about,” “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the devices and/or methods disclosed and claimed herein can be made and executed without undue experimentation in light of the present disclosure. While the devices and/or methods of this invention have been described in terms of particular embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope, and concept of the invention as defined by the appended claims.

Furthermore, no limitations are intended to the details of construction or design herein shown, other than as described in the claims below. It is therefore evident that the particular embodiments disclosed above may be altered or modified and all such variations are considered within the scope and spirit of the disclosure. Accordingly, the protection sought herein is as set forth in the claims below.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order.

To aid the Patent Office, and any readers of any patent issued on this application in interpreting the claims appended hereto, applicants wish to note that they do not intend any of the appended claims to invoke 35 U.S.C. § 112(f) as it exists on the date of filing hereof unless the words “means for” or “step for” are explicitly used in the particular claim.

What is claimed is:

1. A method of reducing corrosion in a heat exchanger comprising:
providing the heat exchanger having a ceramic-nitride material separating a first fluid and a second fluid and/or gaseous fluid; and
transferring a heat from the first fluid to the second fluid and/or gaseous fluid via the ceramic-nitride material, wherein the ceramic-nitride material is corrosion resistant.

2. The method of claim 1, wherein the ceramic-nitride material comprises a silicon-nitride material, an aluminum-nitride material, a boron-nitride material, or a combination thereof.

3. The method of claim 1, wherein:
the first fluid comprises molten salt; and
the second fluid and/or gaseous fluid comprise steam, helium or carbon dioxide.

4. The method of claim 3, wherein the molten salt contains thorium fluoride.

5. The method of claim 1, wherein the heat exchanger is coupled to a molten salt reactor.

6. The method of claim 5, wherein the molten salt reactor is used to turn radioactive waste into waste that is not radioactive.

7. The method of claim 1, wherein the heat exchanger is coupled to a turbine-generator that produces electricity.

8. A heat exchanger comprising:
a vessel; and
a ceramic-nitride material disposed within the vessel and configured to separate a first fluid and a second fluid and/or gaseous fluid, and transfer a heat from the first fluid to the second fluid and/or gaseous fluid.

9. The heat exchanger of claim 8, wherein the ceramic-nitride material comprises a silicon-nitride material, an aluminum-nitride material, a boron-nitride material, or a combination thereof.

10. The heat exchanger of claim 8, wherein the ceramic-nitride material is corrosion resistant.

11. The heat exchanger of claim 8, wherein:
the first fluid comprises molten salt; and
the second fluid and/or gaseous fluid comprise steam, helium or carbon dioxide.

12. The heat exchanger of claim 11, wherein the molten salt contains thorium fluoride.

13. The heat exchanger of claim 8, wherein the heat exchanger is coupled to a molten salt reactor.

14. The heat exchanger of claim 13, wherein the molten salt reactor is used to turn radioactive waste into waste that is not radioactive.

15. The heat exchanger of claim 8, wherein the heat exchanger is coupled to a turbine-generator that produces electricity.

16. A method of transferring heat comprising:
providing a heat exchanger;
passing a first fluid and a second fluid and/or gaseous fluid through the heat exchanger, wherein first fluid is separated from the second fluid and/or gaseous fluid by a ceramic-nitride material; and
transferring the heat from the first fluid to the second fluid and/or gaseous fluid using the ceramic-nitride material.

17. The method of claim 16, wherein the ceramic-nitride material comprises a silicon-nitride material, an aluminum-nitride material, a boron-nitride material, or a combination thereof.

18. The method of claim 16, wherein the ceramic-nitride material is corrosion resistant.

19. The method of claim 16, wherein:
the first fluid comprises molten salt; and
the second fluid and/or gaseous fluid comprise steam, helium or carbon dioxide.

20. The method of claim 18, wherein the molten salt contains thorium fluoride.

21. The method of claim 16, wherein the heat exchanger is coupled to a molten salt reactor.

22. The method of claim 21, wherein the molten salt reactor is used to turn radioactive waste into waste that is not radioactive.

23. The method of claim 16, wherein the heat exchanger is coupled to a turbine-generator that produces electricity.
